(19) United States
(12) Patent Application Publication
(10) Pub. No.: US 2025/0061005 A1
(43) Pub. Date: Feb. 20, 2025

(54) DEVICES AND METHODS FOR DYNAMIC ADAPTIVE THREADING

(71) Applicant: MEDIATEK INC., Hsinchu City (TW)

(72) Inventors: Chung-Yang CHEN, Hsinchu City (TW); Cheng-Che CHEN, Hsinchu City (TW); Chung-Hao HO, Hsinchu City (TW); Yi-Wei HO, Hsinchu City (TW); Yen-Po CHIEN, Hsinchu City (TW); Yen-Ting PAN, Hsinchu City (TW)

(21) Appl. No.: 18/805,816

(22) Filed: Aug. 15, 2024

Related U.S. Application Data
(60) Provisional application No. 63/520,375, filed on Aug. 18, 2023.

(51) Int. Cl. G06F 9/50

(52) U.S. Cl. CPC G06F 9/5055

(57) ABSTRACT

A method for dynamic adaptive threading is provided. The method comprises receiving a query request for a recommended number of threads from an application. The method comprises determining the recommended number of threads according to a resource status of a system-on-a-chip (SoC) platform. The method comprises transmitting the recommended number of threads to the application.

### CROSS REFERENCE TO RELATED APPLICATIONS

This application claims priority under 35 U.S.C. § 119 from U.S. Provisional Application No. 63/520,375, entitled “Mediatek app task efficiency co-pilot”, filed on Aug. 18, 2023, the subject matter of which is incorporated herein by reference.

### BACKGROUND OF THE INVENTION

### Field of the Invention

The present disclosure generally relates to thread processes. More specifically, aspects of the present disclosure relate to devices and methods for dynamic adaptive threading.

### Description of the Related Art

Modern computing devices include traditional platforms such as laptops and rack servers, as well as more contemporary devices such as smartphones, tablets, and Internet-of-Things (IoT) devices. Despite the variety in implementations and platforms, these devices all share a basic architecture of components that include a processor (sometimes referred to as a Central Processing Unit (CPU)), computer-readable memory, software instructions stored in the memory and performed by the processor, and a network interface that allows the device to communicate across a computer network.

There are many different types of each of these components that may be used to implement this basic architecture. For example, there are numerous types of processors that may be classified into groups based on such things as number of independently operating processing units, referred to as cores (e.g., single core, dual core, or quad core). Processors that include multiple cores are able to perform multiple sub-processes in parallel as threads of execution, or simply “threads.” This allows the processor to execute multiple commands from a software-based process at the same time.

Applications such as games or game engines should be designed to prioritize a better user experience, which typically includes good performance and lower power consumption. Achieving this relies on thread parallelism and efficient task placement. For example, determining the optimal moment to split a job worker, like the render thread of Unreal RHI, into multiple threads can improve both performance and power efficiency.

However, the challenge lies in the fact that application programmers and game developers often lack awareness of the capacity of the system-on-a-chip (SoC) or platform, as well as real-time information about platform resource usage. Consequently, it is difficult for the application to fully leverage the available platform resources in the most optimal manner, whether they be software or hardware.

Therefore, there is a need for devices and methods for dynamic adaptive threading to solve this problem.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the devices and methods for dynamic adaptive threading provided in the present disclosure may enable the application to adjust the number of threading used by the application according to the recommended number of threads provided by the platform resource monitor to optimize the performance and resource utilization of the application.

In an exemplary embodiment, a method for dynamic adaptive threading is provided. The method is executed by an electronic device. The method comprises receiving a query request for a recommended number of threads from an application. The method comprises determining the recommended number of threads according to a resource status of a system-on-a-chip (SoC) platform. The method comprises transmitting the recommended number of threads to the application.

In some embodiments, the method further comprises receiving a response from the application, wherein the response includes an actual number of threads used by the application. The method further comprises regularly monitoring the resource status of the SoC platform to determine whether to update the recommended number of threads.

In some embodiments, the method further comprises determining whether a runnable thread ratio of the application is greater than a threshold. The method further comprises transmitting a notification message to notify the application to reduce a demand loading of the application in response to determining that the runnable thread ratio of the application is greater than the threshold.

In some embodiments, the method further comprises determining whether a number of idle central processing unit (CPU) cores exceeds a threshold; and transmitting a notification message to notify the application to split an actual number of threads used by the application into a first number of threads; wherein the first number of threads is higher than the actual number of threads.

In some embodiments, the resource status of the SoC platform comprises a number of idle CPU cores, a core load state, architectures of CPU cores, or core capabilities.

In some embodiments, the query request is received from the application through an Application Programming Interface (API).

In an exemplary embodiment, a device for dynamic adaptive threading is provided. The device comprises one or more processors and one or more computer storage media for storing one or more computer-readable instructions. The processor is configured to drive the computer storage media to execute the following tasks. The processor receives a query request for a recommended number of threads from an application. The processor determines the recommended number of threads according to a resource status of a system-on-a-chip (SoC) platform. The processor transmits the recommended number of threads to the application.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a block diagram of a software structure of an electronic device for dynamic adaptive threading according to an embodiment of the disclosure.

FIG. 2 is a flowchart showing a method for dynamic adaptive threading according to an embodiment of the present disclosure.

FIG. 3 illustrates an exemplary operating environment for implementing embodiments of the present disclosure.

### DETAILED DESCRIPTION OF THE INVENTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

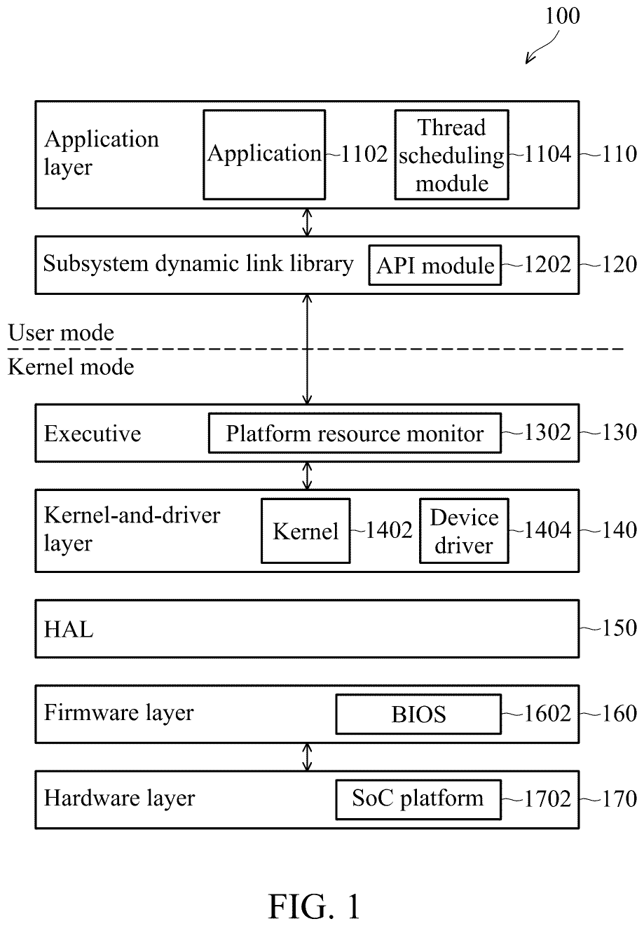

FIG. 1 is a block diagram of a software structure of an electronic device 100 for dynamic adaptive threading according to an embodiment of the disclosure.

In the layered architecture, software is divided into several layers, each layer playing a clearly defined role and function. Different layers communicate with each other through a software interface. In some embodiments, a process in the operating system of the electronic device 100 may run in a user mode or kernel mode. A user-mode architecture includes an application layer 110 and a subsystem dynamic link library 120. A kernel-mode architecture is divided into an executive 130, a kernel-and-driver layer 140, a hardware abstraction layer (HAL) 150, a firmware layer 160 and a hardware layer 170 from top to bottom. As shown in FIG. 1, the application layer 110 includes applications (APPs) 1102 such as music, video, game, office, and social. The application layer 110 further includes a thread scheduling module 1104, and the like. What is shown in the drawing is only a part of the applications. The application layer may further include other applications such as shopping app and browser, without being limited herein.

The thread scheduling module 1104 may obtain the resource status of the electronic device 100, and adaptively schedule and/or split threads for execution that conflict too much with already running/scheduled threads based on the resource status of the electronic device 100.

The subsystem dynamic link library 120 may include an Application Programming Interface (API) module 1202. The API module 1202 may include multiple APIs. The APIs may provide a system call entry and internal function support for an application.

The executive 130 includes modules such as a platform resource monitor 1302.

The platform resource monitor 1302 manages resource status changes of the electronic device 100 and monitor a runtime object.

The kernel-and-driver layer 140 includes a kernel 1402 and a device driver 1404.

The kernel 1402 is an abstraction of the processor architecture and isolates the difference between the executive 130 and the processor architecture to ensure portability of the system. The kernel 1402 performs thread arrangement and scheduling, trap handling, exception scheduling, interruption handling and scheduling, and the like.

The device driver 1404 runs in a kernel mode and serves as an interface between the I/O system and related hardware. The device driver 1404 may include a graphics card driver, a mouse driver, an audio and video driver, a camera driver, a keyboard driver, and the like. For example, the graphics card driver drives the GPU to run.

The HAL 150 is a kernel-mode module and can hide various hardware-related details such as an I/O interface, an interrupt controller, and a multi-processor communication mechanism. The HAL 150 provides a unified service interface for different hardware platforms that run the operating system and implements portability across diverse hardware platforms. It is to be noted that, in order to maintain the portability of the operating system, the internal components and user-written device drivers of the operating system access the hardware not directly, but by calling a routine in the HAL 150.

The firmware layer 160 may include a Basic Input Output System (BIOS) 1602. The BIOS 1602 is a set of programs solidified in a read-only memory (ROM) chip on a computer mainboard. The BIOS 1602 stores the basic input output program, self-test program during power-on, and a system self-starting program that are most essential on the computer and can read and write specific information of system settings from a complementary metal oxide semiconductor (CMOS). A main function of the BIOS 1602 is to provide the computer with the lowest-level and most direct hardware setting and control.

The hardware layer 170 may include a system-on-a-chip (SoC) platform 1702. The SoC platform 1702 may include one or more central processing unit (CPU) cores, a memory controller, peripheral components, and other hardware components.

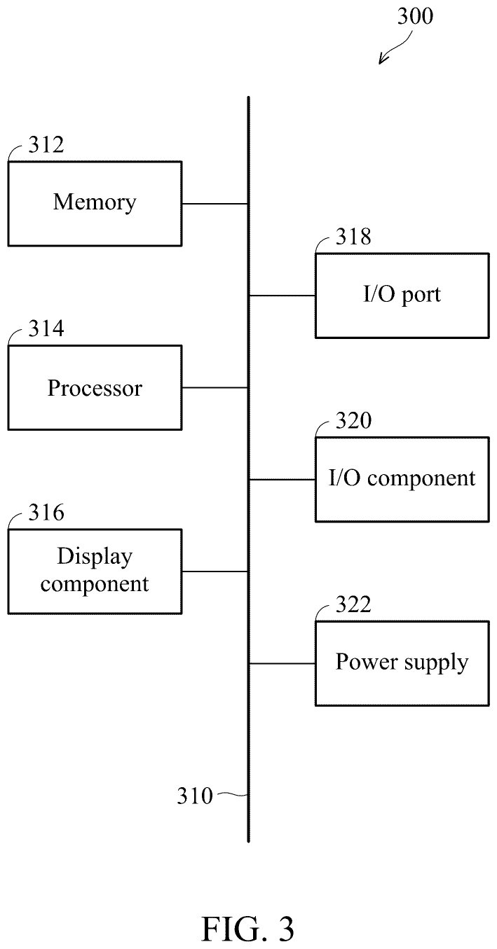

It should be understood that the electronic device 100 shown in FIG. 1 is an example of the device for dynamic adaptive threading. The electronic device 100 shown in FIG. 1 may be implemented through any type of electronic device, such as the electronic device 300 described with reference to FIG. 3, for example.

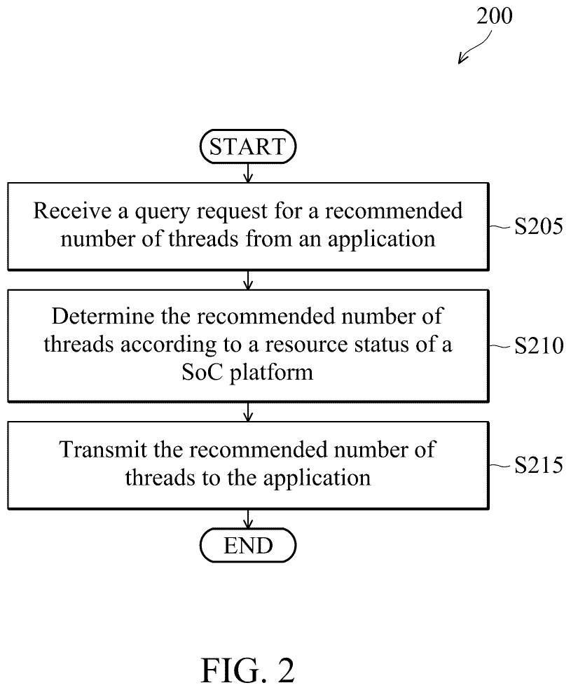

FIG. 2 is a flowchart 200 showing a method for dynamic adaptive threading according to an embodiment of the present disclosure. This flowchart 200 is executed by the platform resource monitor 1302 in the electronic device 100 for dynamic adaptive threading in FIG. 1.

In step S205, the platform resource monitor receives a query request for a recommended number of threads from an application, wherein the query request is received from the application through an API.

In step S210, the platform resource monitor determines the recommended number of threads according to a resource status of a SoC platform, wherein the resource status of the SoC platform comprises a number of idle CPU cores, a core load state, architectures of the CPU cores, or the core capabilities.

In step S215, the platform resource monitor transmits the recommended number of threads to the application.

For instance, by analyzing previous frame CPU core loading, the platform resource monitor may recommend a recommended number of threads N when identifying that N CPU cores have a loading below a threshold (for example, 20%). The recommended number N provides valuable information for the application to optimize its performance and resource utilization.

For another instance, the platform resource monitor may hint the application to change the CPU core affinity when the application wants to bind a thread on a CPU core with a loading greater than a threshold (for example, 90%), indicating that the thread is already occupied by other tasks.

It should be noted that although the thresholds 20% and 90% are used in those examples as an illustration, it is not limited to the disclosure.

In one embodiment, the platform resource monitor may receive a response from the application, wherein the response includes the actual number of threads used by the application. The platform resource monitor regularly monitors the resource status of the SoC platform to determine whether to update the recommended number of threads.

In another embodiment, the platform resource monitor may determine whether the runnable thread ratio of the application is greater than a threshold. The platform resource monitor transmits a notification message to notify the application to reduce the demand loading of the application in response to determining that the runnable thread ratio of the application is greater than the threshold. For example, when the platform resource monitor detects that the runnable thread ratio of the application exceeds 20% of frame time, the platform resource monitor notifies the application to lower its demand loading.

In some embodiments, the platform resource monitor may determine whether the number of idle CPU cores exceeds a threshold. The platform resource monitor transmits a notification message to notify the application to split the actual number of threads used by the application into a first number of threads, wherein the first number of threads is higher than the actual number of threads. For instance, when the platform resource monitor determines the availability of spare CPU cores, the platform resource monitor may notify the application to split its threads into multiple threads, enabling improved performance and power efficiency.

As mentioned above, the devices and methods for dynamic adaptive threading proposed in the present disclosure may enable the application to adjust the number of threading used by the application according to the recommended number of threads provided by the platform resource monitor to optimize the performance and resource utilization of the application.

It should be noted that the embodiment in FIG. 1 can be implemented in hardware, software, firmware or any combination thereof. For example, the application 1102 and the platform resource monitor 1302 may each be implemented as computer program codes executed by one or more processors. Alternatively, the application 1102 and the platform resource monitor 1302 may be implemented as hardware logic/circuit respectively.

Having described embodiments of the present disclosure, an exemplary operating environment in which embodiments of the present disclosure may be implemented is described below. Referring to FIG. 3, an exemplary operating environment for implementing embodiments of the present disclosure is shown and generally known as an electronic device 300. The electronic device 300 is merely an example of a suitable computing environment and is not intended to limit the scope of use or functionality of the disclosure. Neither should the electronic device 300 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 3, the electronic device 300 may include a bus 310 that is directly or indirectly coupled to the following devices: one or more memories 312, one or more processors 314, one or more display components 316, one or more input/output (I/O) ports 318, one or more input/output components 320, and an illustrative power supply 322. The bus 310 may represent one or more kinds of busses (such as an address bus, data bus, or any combination thereof). Although the various blocks of FIG. 3 are shown with lines for the sake of clarity, and in reality, the boundaries of the various components are not specific. For example, the display component such as a display device may be considered an I/O component and the processor may include a memory.

The electronic device 300 typically includes a variety of computer-readable media. The computer-readable media can be any available media that can be accessed by electronic device 300 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the electronic device 300. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 312 may include computer-storage media in the form of volatile and/or nonvolatile memory. The memory may be removable, non-removable, or a combination thereof. Exemplary hardware devices include solid-state memory, hard drives, optical-disc drives, etc. The electronic device 300 includes one or more processors that read data from various entities such as the memory 312 or the I/O components 320. The display component(s) 316 present data indications to a user or to another device. Exemplary presentation components include a display device, speaker, printing component, vibrating component, etc.

The I/O ports 318 allow the electronic device 300 to be logically coupled to other devices including the I/O components 320, some of which may be embedded. Illustrative components include a microphone, joystick, game pad, satellite dish, scanner, printer, wireless device, etc. The I/O components 320 may provide a natural user interface (NUI) that processes gestures, voice, or other physiological inputs generated by a user. For example, inputs may be transmitted to an appropriate network element for further processing. A NUI may be implemented to realize speech recognition, touch and stylus recognition, facial recognition, biometric recognition, gesture recognition both on screen and adjacent to the screen, air gestures, head and eye tracking, touch recognition associated with displays on the electronic device 300, or any combination thereof. The electronic device 300 may be equipped with depth cameras, such as stereoscopic camera systems, infrared camera systems, RGB camera systems, or any combination thereof, to realize gesture detection and recognition. Furthermore, the electronic device 300 may be equipped with accelerometers or gyroscopes that enable detection of motion. The output of the accelerometers or gyroscopes may be provided to the display of the electronic device 300 to carry out immersive augmented reality or virtual reality.

Furthermore, the processor 314 in the electronic device 300 can execute the program code in the memory 312 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for dynamic adaptive threading, executed by a processor of an electronic device, the method comprising:
receiving a query request for a recommended number of threads from an application;
determining the recommended number of threads according to a resource status of a system-on-a-chip (SoC) platform; and
transmitting the recommended number of threads to the application.

2. The method of dynamic adaptive threading as claimed in claim 1, further comprising:
receiving a response from the application, wherein the response includes an actual number of threads used by the application; and
regularly monitoring the resource status of the SoC platform to determine whether to update the recommended number of threads.

3. The method of dynamic adaptive threading as claimed in claim 1, further comprising:
determining whether a runnable thread ratio of the application is greater than a threshold; and
transmitting a notification message to notify the application to reduce a demand loading of the application in response to determining that the runnable thread ratio of the application is greater than the threshold.

4. The method of dynamic adaptive threading as claimed in claim 1, further comprising:
determining whether a number of idle central processing unit (CPU) cores exceeds a threshold; and
transmitting a notification message to notify the application to split an actual number of threads used by the application into a first number of threads;
wherein the first number of threads is higher than the actual number of threads.

5. The method of dynamic adaptive threading as claimed in claim 1, wherein the resource status of the SoC platform comprises a number of idle CPU cores, a core load state, architectures of CPU cores, or core capabilities.

6. The method of dynamic adaptive threading as claimed in claim 1, wherein the query request is received from the application through an Application Programming Interface (API).

7. A device for dynamic adaptive threading, comprising:
one or more processors; and
one or more computer storage media for storing one or more computer-readable instructions, wherein the processor is configured to drive the computer storage media to execute the following tasks:
receiving a query request for a recommended number of threads from an application;
determining the recommended number of threads according to a resource status of a system-on-a-chip (SoC) platform; and
transmitting the recommended number of threads to the application.

8. The device for dynamic adaptive threading as claimed in claim 7, wherein the processor further executes the following tasks:
receiving a response from the application, wherein the response includes an actual number of threads used by the application; and
regularly monitoring the resource status of the SoC platform to determine whether to update the recommended number of threads.

9. The device for dynamic adaptive threading as claimed in claim 7, wherein the processor further executes the following tasks:
determining whether a runnable thread ratio of the application is greater than a threshold; and
transmitting a notification message to notify the application to reduce a demand loading of the application in response to determining that the runnable thread ratio of the application is greater than the threshold.

10. The device for dynamic adaptive threading as claimed in claim 7, wherein the processor further executes the following tasks:
determining whether a number of idle central processing unit (CPU) cores exceeds a threshold; and
transmitting a notification message to notify the application to split an actual number of threads used by the application into a first number of threads;
wherein the first number of threads is higher than the actual number of threads.

11. The device for dynamic adaptive threading as claimed in claim 7, wherein the resource status of the SoC platform comprises a number of idle CPU cores, a core load state, architectures of CPU cores, or core capabilities.

12. The device for dynamic adaptive threading as claimed in claim 7, wherein the query request is received from the application through an Application Programming Interface (API).
